(19) United States
(12) Patent Application Publication
(10) Pub. No.: US 2016/0129722 A1
(43) Pub. Date: May 12, 2016

(54) WRITING INSTRUMENT WITH AN INDENTED GRASPING AREA

(71) Applicant: The Berea Hardwoods Co., Inc., Middleburg Heights, OH (US)

(72) Inventor: Joseph M. Csokmay, Parma, OH (US)

(73) Assignee: The Berea Hardwoods Co., Inc.

(21) Appl. No.: 14/924,057

(22) Filed: Oct. 27, 2015

Related U.S. Application Data
(60) Provisional application No. 62/077,540, filed on Nov. 10, 2014.

(51) Int. Cl. B43K 23/008; B43K 5/00; B43K 21/00

(52) U.S. Cl. CPC B43K 23/008; B43K 21/006; B43K 5/005

(57) ABSTRACT

A writing instrument is disclosed. The writing instrument includes a casing having a first end, a second end, and a longitudinal axis extending therebetween. A bore is defined in the casing and an opening to the bore is defined in the first end of the casing. An ink cartridge is received in the bore and a tip of the cartridge extends outwardly through the opening. The casing includes a grasping area located a distance inwardly from the first end. The grasping area is of a first cross-sectional shape and the rest of the casing is of a second cross-sectional shape. The grasping area is generally triangular while the rest of the casing is generally cylindrical. The triangular shape is formed by six different regions being formed in the wall of the casing; where every second region is a U-shaped depression. The depressions run substantially parallel to the casing's longitudinal axis.

### CROSS-REFERENCE TO RELATED APPLICATIONS

This application claims the benefit of U.S. Provisional Patent Application Ser. No. 62/077,540 filed Nov. 10, 2014, the entire disclosure of which is incorporated herein by reference.

### BACKGROUND OF THE INVENTION

1. Technical Field

This invention relates generally to writing instruments such as pens and pencils. More particularly, this invention is directed to a writing instrument having a casing with an indented grasping area located a distance from the tip of the writing instrument, wherein the indented grasping area is generally triangular in cross-section and wherein a remaining portion of the casing is generally circular in cross-section.

2. Background Information

Writing instruments such as pens and pencils are gripped between the fingers and thumb of one hand during use. One of the biggest issues that people have with such writing instruments is that the cylindrical casing has to be tightly grasped in order to prevent the casing from rotating while writing or drawing with the writing instrument. This need to tightly grasp the implement may tend to lead to fatigue in the hand and, in the case of some users, can also result in callouses forming on one or more fingers.

In order to reduce the need to tightly grip the pen or pencil, some manufacturers have taken action. Pencil manufactures have tended to change the cross-sectional shape of the pencil along its entire length. In some instances, three or more facets have been cut into the wood used to fabricate the pencil so that the pencil has a cross-sectional shape which resists the tendency of the pencil to rotate within the gripping fingers when in use. This cross-sectional shape is maintained for substantially the entire length of the pencil. This ensures that as the pencil is sharpened the next region thereof, which becomes the grasping area, will possess the desired cross-sectional shape. It is customary at present for around six facets to be cut into the wood during fabrication of pencils.

Many manufacturers of pens have adopted a similar solution, forming plastic casings or barrels that are other than cylindrical. For example, the United Kingdom Patent GB741,101 (Ferber Corporation) discloses in FIGS. 3 and 4, a ball-point pen that is generally triangular in cross-sectional shape. As is evident from FIG. 4 thereof, this cross-sectional shape of the pen is maintained along substantially the entire length of the casing of the pen.

U.S. Pat. No. 6,145,986 (Conner) discloses a casing for a pen/glasses case that can be any one of a number of different cross-sectional shapes. These cross-sectional shapes include generally elliptical (FIGS. 3 and 8), square (FIG. 4), circular (FIG. 5), triangular (FIG. 6) and generally rectangular (FIG. 7). Again, the elliptical, square, circular, triangular and rectangular cross-sectional shape is maintained for substantially the entire length of the pen's casing.

JP2006021430 (Anzai Sadahiro) discloses a pen casing that is provided with six facets and is generally triangular in cross-sectional shape. Again, this cross-sectional shape is maintained for substantially the entire length of the pen's casing.

Even though these writing instruments have been provided with faceted regions for easier gripping of their casings it may still be relatively uncomfortable for a user to grip the writing instrument for protracted periods of time. Some manufacturers have addressed this issue by providing a cushion that may be engaged with the casing. The cushion may slide along the casing and thereby be moved to a position where the cushion may be grasped by the user. For example, U.S. Patent D396,059 (Plantz et al) shows a cushion that is generally triangular in shape and includes shallow elliptically shaped depressions for placement of the user's fingers thereon. The cushion is designed to be placed around the circumference of the pen or pencil casing and includes an aperture surrounded by knurling for gripping said pen or pencil.

Yet other manufacturers have addressed this issue by providing some type of indentation in the exterior surface of the casing. For example, U.S. Patent D628,240 shows a writing instrument where a shallow depression is provided in one region of the casing's surface, specifically where the index finger of the user would be seated when the pen is gripped. This shallow depression runs from a distance from the tip to a region proximate where the upper and lower sections of the pen are engaged with each other.

### SUMMARY

There remains a need in the art for an improved writing instrument that is easy to grasp and does not tend to rotate in the user's fingers during use.

The writing instrument disclosed herein includes a casing having a first end and a second end and a longitudinal axis extending therebetween. A bore is defined in the casing and an opening to the bore is defined in the first end of the casing. An ink cartridge is received in the bore and a tip of the cartridge extends outwardly through the opening. The casing includes a grasping area located a distance inwardly from the first end and thereby from the tip of the ink cartridge. The grasping area is of a first cross-sectional shape and a remaining portion of the casing is of a second and different cross-sectional shape. The grasping area is generally triangular in cross-section while the rest of the casing may be of any other cross-sectional shape but preferably is generally circular in cross-section. The triangular shape is formed by six different faces being provided in the casing; where every second face is a U-shaped depression. The depressions run substantially parallel to the casing's longitudinal axis.

In one aspect, the invention may provide a writing instrument comprising a casing having a first end and a second end and a longitudinal axis extending between the first and second ends; and a grasping area provided on the casing in a location between the first and second ends; wherein the grasping area is of a first cross-sectional shape and a remaining portion of the casing is of a second cross-sectional shape.

In another aspect the grasping area may be generally triangular in cross-section while the remaining portion of the casing is generally circular. The generally triangular part of the grasping area may include surfaces that are recessed relative to the remaining portion of the casing and to other regions of the grasping area.

### BRIEF DESCRIPTION OF THE SEVERAL VIEWS OF THE DRAWINGS

A sample embodiment of the invention is set forth in the following description, is shown in the drawings and is particularly and distinctly pointed out and set forth in the appended claims.

FIG. 1 is a perspective view of a writing instrument in accordance with an aspect of the present invention;

FIG. 2 is a front view thereof;

FIG. 3 is a rear view thereof;

FIG. 4 is a right side view thereof;

FIG. 5 is a left side view thereof;

FIG. 6 is a cross-section taken along line 6-6 of FIG. 2; and

FIG. 7 is a cross-section taken along line 7-7 of FIG. 2.

Similar numbers refer to similar parts throughout the drawings.

### DETAILED DESCRIPTION

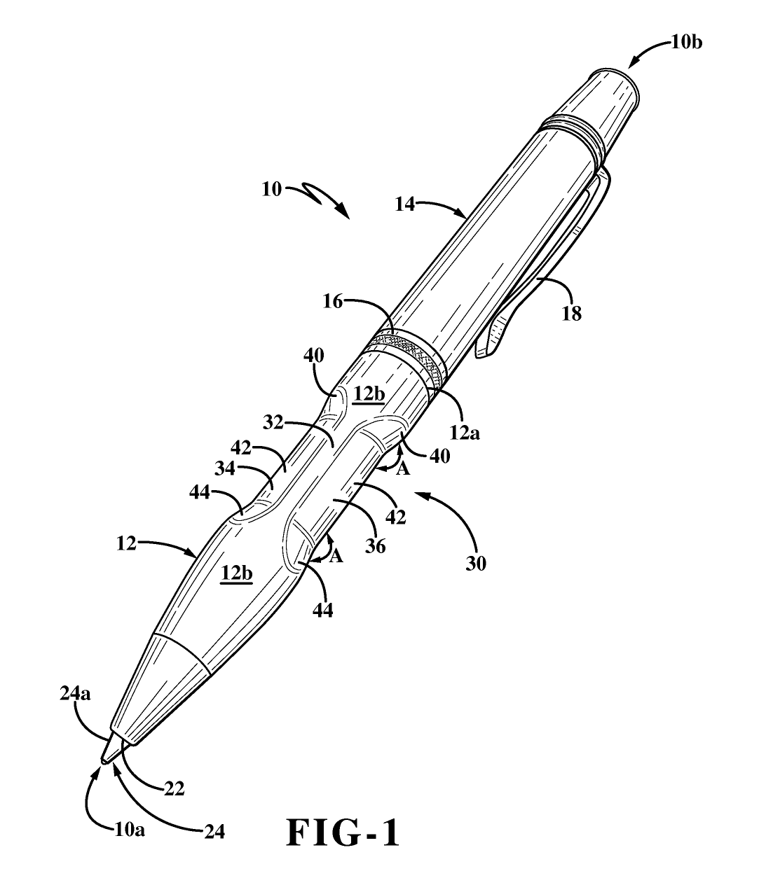

Referring to FIGS. 1-8 there is shown a writing instrument in accordance with an aspect of the present invention, generally indicated at 10. Writing instrument 10 may be a pen or a mechanical pencil. For ease of reference, the writing instrument will further be described herein as “pen 10” but it will be understood that a mechanical pencil or a non-mechanical pencil or any other writing implement may be similarly configured. Additionally, the configuration of the gripping area described further herein may be applied to any generally cylindrical object that is typically gripped during use, for example paint brushes or medical instruments. The term “pen” or writing implement should be contemplated to include these other cylindrical objects

Pen 10 is illustrated as being a fountain-pen style but it will be understood that other styles of pen such as a ball-point pen may similarly include an indented grasping area as will be further described herein.

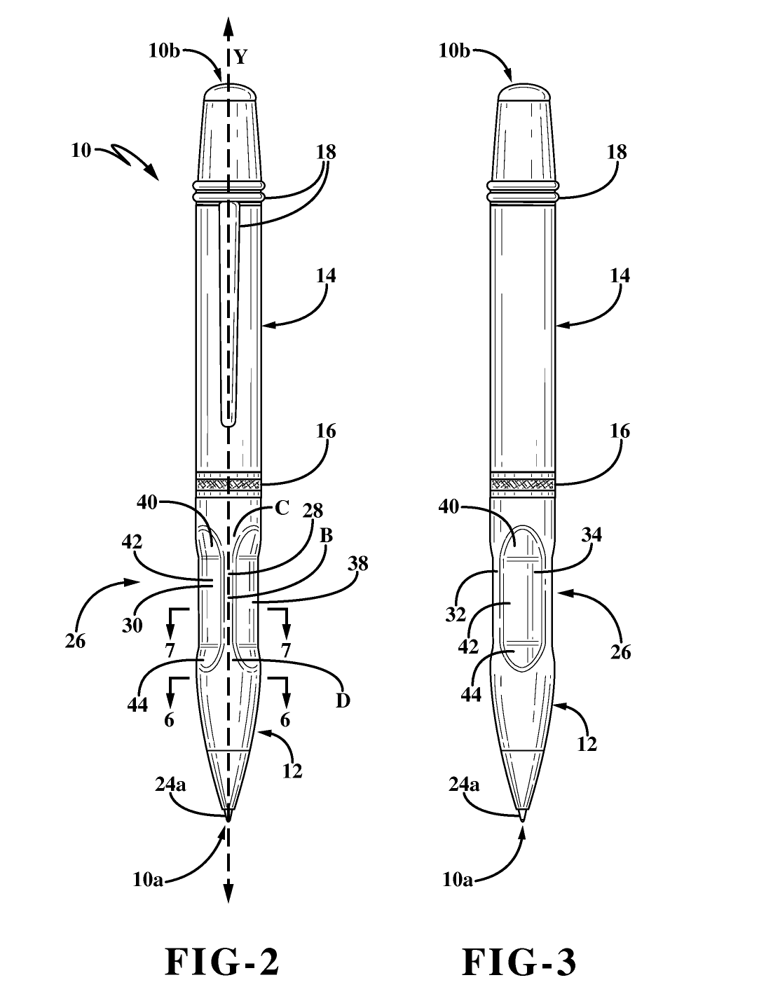

Pen 10 has a first end 10a and a second end 10b and a longitudinal axis “Y” (FIG. 2) extending between first and second ends 10a, 10b. The first end 10a of pen 10 is the writing end. Pen 10 includes a tubular casing that is comprised of a first region 12 and a second region 14 (because this pen is a fountain-style pen. The casing of a ball point pen or a pencil would only comprise a first region 12.) First and second regions 12, 14 may be detachably engaged with each other as is well known in the art. A knurled ring 16 may be provided adjacent the portion of pen 10 where the ends of first and second regions 12, 14 abut each other. First region 12 will be described in greater detail hereafter. Second region 14 may be generally circular in cross-sectional shape and include a clip member 18 that extends outwardly therefrom and is oriented generally parallel to longitudinal axis “Y”. A clip member 18 may be provided on second region 14 so that a user may latch pen 10 to a user's pocket, onto a folder or the like.

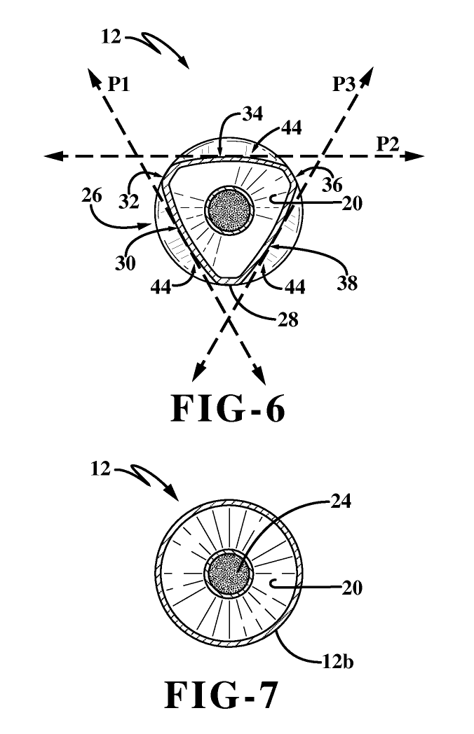

The casing of pen 10 defines a bore 20 (FIGS. 6 and 7) therein that extends from proximate first end 10a to proximate second end 10b. An opening 22 to bore 20 is defined in first end 10a. An ink cartridge 24 is received within bore 20 and a tip 24a thereof protrudes outwardly through opening 22 and forms the writing tip of the pen 10. Pen 10 may include a retractor mechanism for selectively moving ink cartridge longitudinally within bore 20. This retractor mechanism, if provided, enables the user to retract tip 24a so that tip 24a no longer extends outwardly through opening 22 or extend tip 24a so that tip 24a is extends outwardly through opening 22.

First region 12 of the casing includes the first end 10a that defines opening 22 therein. First region 12 may also include a second end 12a that is positionable adjacent second region 14 and contacts ring 16. In accordance with an aspect of the invention, first region 12 may be shaped to form a grasping area 26 in a location intermediate first end 10a and second end 12a. Grasping area 26 is provided a distance inwardly from first end 10a. If the pen's casing does not include a second region 14 or if the first region 12 is of a particularly small length (defined between end 10a and second end 12a), then the grasping area 26 will be formed in at an appropriate location along the casing that is suitable for gripping the pen 10.

In accordance with another aspect of the invention and as seen in FIGS. 6 and 7, grasping area 26 is of a first cross-sectional shape and a remaining portion of the casing is of a second cross-sectional shape. The remaining portion of the casing is identified by the reference number 12b. FIG. 7 shows that the remaining portion of the casing 12b may be generally circular in cross-sectional shape. It should be noted that second region 14 may similarly be generally circular in cross-sectional shape. It will be understood that portion 12b and second region 14 may be of any cross-sectional configuration other than circular.

Grasping area 26 may be generally triangular in cross-section as is illustrated in FIG. 6. Grasping area 26 may be comprised of a first, second, and third face 30, 34, 38 that are formed in the casing of pen 10 and are oriented at angles relative to each other so that together they generally form an equilateral triangle when viewed from one end. Adjacent faces are separated from each other by corner regions. These faces and corner regions are best seen in FIG. 6 and are identified as first corner region 28, first face 30, second corner region 32, second face 34, third corner region 36, and third face 38. First face 30 is located generally in a first plane “P1” (FIG. 6), second face 34 is located generally in a second plane “P2”, and third face 38 is located generally in a third plane “P3”. It should be noted that while each of the first, second and third faces 30, 34, 38 are located generally in a plane, each of the first, second and third faces are slightly curved. The curvature of first, second and third faces 30, 34, 38 is such that the faces are convex.

First plane “P1” is at an angle relative to second plane “P2”, second plane “P2” is at an angle relative to third plane “p3”, and third plane “P3” is at an angle relative to first plane “P1”. The orientation of first, second and third planes “P1”, “P2”, and “P3” is such that they generally form an equilateral triangular shape. First and third faces 30, 38 meet along first corner region 28, first and second faces 30, 34 meet along second corner region 32 and second and third faces 34, 38 meet along third corner region 36. First, second and third corner regions 28, 32, 36 are of similar widths (as measured from one face to the adjacent face) and have slightly rounded edges adjacent each face so that grasping area does not present any sharp edges that may be contacted by a user holding pen 10. First, second and third corner regions 28, 32, 36 may be substantially continuous with the exterior surface of the rest 12b of the cylindrically-shaped first region 12 of pen 10. This cylindrical exterior surface is identified by the reference character 12b in FIGS. 1 and 7. Each of the first, second and third corner regions 28, 32, 36 may be generally “I-shaped” when pen 10 is viewed from the front as is illustrated in FIG. 2 having a narrow central portion and two flaring end portions that are continuous with the remaining portion 12b of first region 12.

First face 30, second face 34, and third face 38 are substantially identical to each other and are different to first, second and third corner regions 28, 32, 36. Each of the first, second and third faces 30, 34, 38 is generally U-shaped in longitudinal cross-section (i.e., when viewed from the side) as is illustrated in FIG. 1 and is generally elliptical when pen 10 is viewed from the front as illustrated in FIG. 3.

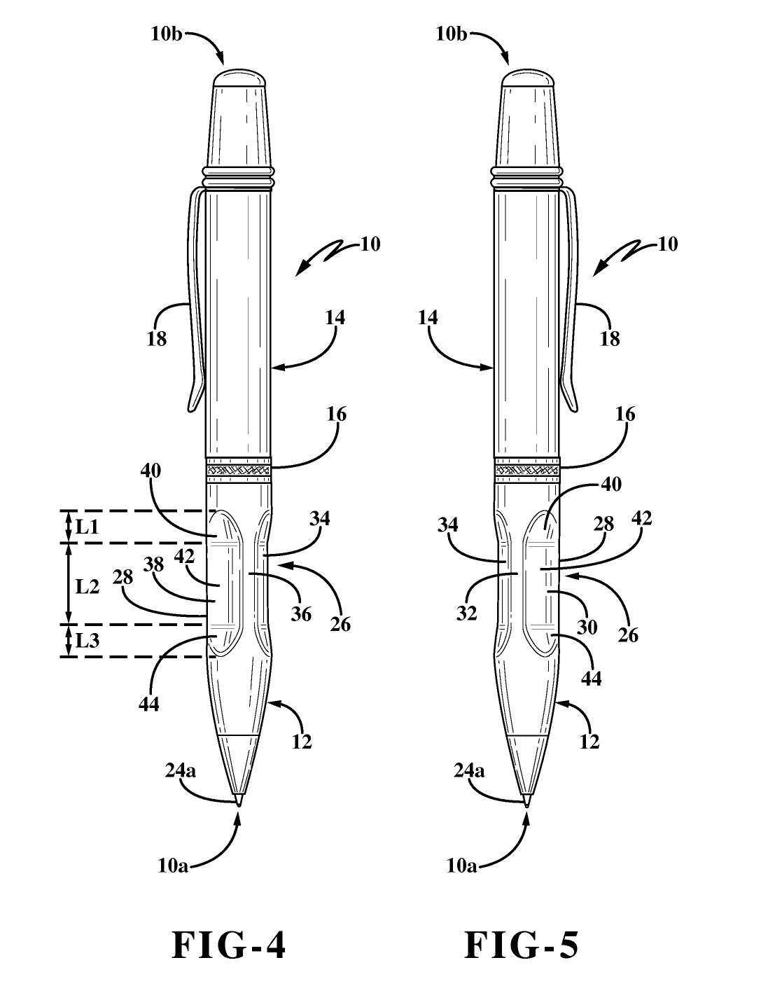

Each of the first, second and third faces 30, 34, 38 includes a first surface 40, a second surface 42 adjacent the first surface 40; and a third surface 44 adjacent the second surface 42. The first and third surfaces 40, 44 flare outwardly away from each other and from opposite ends of second surface 42. Second surface 42 is substantially parallel to the longitudinal axis “Y” of the casing and first and third surfaces 40, 44 are oriented at an angle “A” (FIG. 1) relative to second surface 42. This angle “A” may be from about 25° to about 50° relative to second surface 42. First and third surfaces 40, 44 are each of a first length “L1” (FIG. 4) and the second surface is of a second length “L2” and the second length “L2” is longer than the first length “L1”. The overall length (L1+L2+L1) of the grasping area 26 is about 1 inch long.

It should be noted that relative to first, second and third corner regions 28, 32, 36, the first, second and third faces 30, 34, 38 comprise depressions that defined in the casing. First, second and third faces 30, 34, 38 are recessed relative to the remaining portion 12b of the casing. First, second and third faces 30, 34, 38 are also recessed relative to first, second and third corner regions 28, 32, 36. It should be noted that the first, second and third faces 30, 34, 38, and the first, second and third corner regions 28, 32, 36 may all be integrally formed with and form part of the exterior wall of the casing. The grasping area 26 may thus be an integral part of the casing and not a separate component that is placed around the exterior circumferential surface of the pen's casing. First, second and third corner regions 28, 32, 36 are generally aligned with the remaining portion 12b of the casing as shown in FIG. 6. First, second and third faces are recessed relative to the remaining portion 12b and relative to first, second and third corner regions 28, 32, 36 and are thus not aligned with the remaining portion 12b.

First, second and third corner regions 28, 32, 36 each have an elongate central region “B” that is located between the second surfaces 42 of the respective adjacent first, second and third faces 30, 34, 38. So, for example, as shown in FIG. 2, first corner region 28 has an elongate central region “B” that is positioned between first surface 42 of first face 30 and first surface 42 of third face 38. Each of the first, second and third corner regions 28, 32, 36 also has end regions “C” and “D” that extend outwardly from opposed ends of central region “B”. Central region “B” is thinner than each of the end regions “C” and “D”. Each of the end regions “C” and “D” is broader than the central region “B” and gradually and arcuately increases in width as one moves from central region “B” outwardly toward the remaining portion 12b of the casing. The end region “C” is located between the first surfaces 40 of the respective adjacent first, second and third faces 30, 34, 38 and the end region “D” is located between the third surfaces 44 of the respective adjacent first, second and third faces 30, 34, and 38. So, for example, referring to FIG. 2, end region “C” of first corner region 28 is located between first surface 40 of first face 30 and first surface 40 of third face 38; and end region “D” of first corner region 28 is located between third surface 44 of first face 30 and third surface 44 of third face 38.

A user will grip pen 10 by positioning a part of each of their index finger, middle finger and thumb in the grasping region 26 and so that each of the index and middle fingers and their thumb contacts one of the first, second and third faces 30, 34, and 38. The narrowed, triangular shape helps the user grip the pen more easily and more comfortably. Additionally, because the first, second and third corner regions 28, 32, 36 are positioned between these depressions (faces 30, 34, 38) and because these first, second and third corner regions 28, 32, 36 appear to be raised relative to the first, second and third faces 28, 34, 38, rotation of the pen 10 in the user's hand is substantially prevented or at least retarded. This rotation is substantially prevented or retarded because of contact between the user's fingers and thumb and the relatively raised faces 28, 32, 36.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration set out herein are an example not limited to the exact details shown or described.

1. A writing instrument comprising:
a casing having a first end and a second end and a longitudinal axis extending between the first and second ends; and
a grasping area provided on the casing in a location between the first and second ends; wherein the grasping area is of a first cross-sectional shape and a remaining portion of the casing is of a second cross-sectional shape.

2. The writing instrument as defined in claim 1, wherein the grasping area is generally triangular in cross-section.

3. The writing instrument as defined in claim 2, wherein the remaining portion of the casing is generally circular in cross-section.

4. The writing instrument as defined in claim 1, wherein the grasping area is indented relative to the remaining portion of the casing.

5. The writing instrument as defined in claim 1, wherein the grasping area is an integral part of the casing.

6. The writing instrument as defined in claim 1, wherein the casing has an exterior wall and the grasping area is formed in the exterior wall.

7. The writing instrument as defined in claim 2, wherein the generally triangular grasping area includes a first face; a second face and a third face; and wherein the first face is oriented at an angle to each of the second and third faces; and wherein the second face is oriented at an angle to the third face.

8. The writing instrument as defined in claim 2, wherein the generally triangular grasping area includes a first face oriented generally in a first plane, a second face oriented generally in a second plane, and a third face oriented generally in a third plane; and the first, second and third planes are oriented such that the first, second and third faces generally form an equilateral triangle.

9. The writing instrument as defined in claim 2, wherein the generally triangular grasping area includes a first face, a second face and a third face; and each of the first, second and third faces are recessed relative to an exterior surface of the remaining portion of the casing.

10. The writing instrument as defined in claim 2, wherein the generally triangular grasping area includes a first face, a second face and a third face; and each of the first, second and third faces is generally U-shaped in longitudinal cross-section.

11. The writing instrument as defined in claim 10, wherein each of the first, second and third faces includes a first surface, a second surface adjacent the first surface, and a third surface adjacent the second surface; and wherein the first and third surfaces flare outwardly away from each other and away from opposite ends of the second surface.

12. The writing instrument as defined in claim 11, wherein the second surface is substantially parallel to the longitudinal axis of the casing and the first and third surfaces are oriented at an angle relative to the second surface.

13. The writing instrument as defined in claim 12, wherein the angle is from about 25° to about 50° relative to the second surface.

14. The writing instrument as defined in claim 11, wherein the first and third surfaces are each of a first length and the second surface is of a second length and the second length is longer than the first length.

15. The writing instrument as defined in claim 1, wherein the grasping area includes a first face, a second face and a third face that are oriented generally into a section of the casing that is triangular in cross-section; and wherein a first corner region is located between the first face and the third face; a second corner region is located between the first face and the second face; and a third corner region is located between the second face and the third face; and wherein the first, second and third faces are recessed relative to the first, second and third corner regions.

16. The writing instrument as defined in claim 15, wherein each of the first, second and third corner regions is generally I-shaped when viewed from a front of the writing instrument and includes an elongate and thinner central region and opposed broader ends extending from central region.

17. The writing instrument as defined in claim 16, wherein each of the first, second and third faces is generally U-shaped in longitudinal cross-section and includes a first surface, a second surface adjacent the first surface, and a third surface adjacent the second surface; and wherein the first and third surfaces flare outwardly away from each other and away from opposite ends of the second surface; and wherein the central region of each of the first, second and third corner regions is located between the second surfaces of the respective adjacent first, second and third faces.

18. The writing instrument as defined in claim 17, wherein each of the broader end regions of the first, second, and third corner regions is located between the first surfaces or the third surfaces of the respective adjacent first, second and third faces.

19. The writing instrument as defined in claim 16, wherein the first, second and third corner regions are aligned with the remaining portion of the casing and the first, second and the third faces are recessed relative to the first, second and third corner regions.

20. The writing instrument as defined in claim 1, wherein the casing defines a bore therein, said bore extending from the first end of the casing to proximate the second end thereof; an opening to the bore is defined in the first end of the casing; and an ink cartridge is provided within the bore, said ink cartridge having a tip that is extendable outwardly through the opening.
